(19) United States
(12) Patent Application Publication
(10) Pub. No.: US 2008/0112732 A1
(43) Pub. Date: May 15, 2008

(54) DEVELOPMENT STATION FOR A REPRODUCTION APPARATUS

(76) Inventors: Eric C. Stelter, Pittsford, NY (US); Joseph E. Guth, Holley, NY (US); Laverne N. Lincoln, Macedon, NY (US)

Correspondence Address: David A. Novais;Patent Legal Staff, Eastman Kodak Company, 343 State Street, Rochester, NY, 14650-2201, US

(21) Appl. No.: 11/558,562

(22) Filed: Nov. 10, 2006

(51) Int. Cl. G03G 15/09

(52) U.S. Cl. 399/272

(57) ABSTRACT

A development station is disclosed for a reproduction apparatus such as an electrophotographic printing machine. The development station includes a housing that forms a reservoir and a developer roller such as a magnetic brush for delivering developer material to a development zone. A transport roller is provided for moving developer material from the reservoir to the developer roller. The transport roller includes a rotating non-magnetic tubular shell and a stationary elongated magnetic core having an odd number of alternating North and South magnetic poles. There are at least five magnetic poles in the magnetic core, and preferably exactly five magnetic poles.

### FIELD OF THE INVENTION

This invention relates generally to an electrophotographic printing machine, and more particularly concerns an apparatus for dispensing magnetic developer containing marking particles onto a developer roller of a magnetic brush development system.

### BACKGROUND OF THE INVENTION

In general, the process of electrophotographic printing includes charging a photoconductive member to a substantially uniform potential to sensitize the surface thereof. The charged portion of the photoconductive surface is imagewise exposed to light to discharge selected portions of the charged photoconductive surface and create an electrostatic latent image on the photoconductive surface. The latent image is developed by bringing developer material into contact therewith. Two-component developer material comprises toner particles adhering triboelectrically to carrier granules. The carrier particles are usually magnetic. The toner particles are attracted from the carrier granules to form a powder image on the photoconductive member. The powder image is subsequently transferred to a receiver and heated to permanently affix the powder image to the receiver. With the advent of single-component development, magnetic toner particles are employed to develop the latent image. Generally, these toner particles are dispensed directly onto the developer roller, which transports the magnetic toner particles to the latent image recorded on the photoconductive surface. In this way, a single component developer material is employed to develop the latent image.

Commonly assigned U.S. Pat. No. 6,385,415, issued on May 7, 2002, in the names of Hilbert et al. discloses a magnetic brush development station that includes a reservoir of developer material. A transport mechanism brings the developer material into the field of a plurality of magnets within a sleeve (commonly referred to as a developer roller, toning roller, or magnetic brush). The transport mechanism includes a transport roller (also known as a feed roller) located between the reservoir and the developer roller. The transport roller includes a rotatable, non-magnetic tubular member and a magnet or magnets fixedly disposed interiorly of tubular member to attract the developer material from the reservoir to the transport roller using the force on the developer resulting from the magnetic field of the magnets inside the transport roller.

In early designs, the magnets of the transport roller included three alternating magnetic poles in the region of the transport roller adjacent to the reservoir, and the magnetic flux lines from the North to the South poles attracted the developer material to the transport roller. However, it was quickly determined that the three poles did not exhibit sufficient magnetism to pull enough developer material from the reservoir. Subsequently, the design was changed to include four alternating magnetic poles in the region of the transport roller adjacent to the reservoir, and the magnetic pull was sufficient for commercial use.

### SUMMARY OF THE INVENTION

Although four alternating magnetic poles in the region of the transport roller adjacent to the reservoir caused sufficient developer material to adhere to the transport roller, much of that material was not being transferred to the developer roller and was being returned to the reservoir region as the non-magnetic tubular member continued to rotate. In accordance with the present invention, it has been determined that the use of four alternating magnetic poles in the region of the transport roller adjacent to the reservoir results in the existence of undesirable magnetic flux lines extending around the transport roller across the region of the developer roller. These flux lines resulted in a substantial amount of developer material sticking to the transport roller and not being transferred to the development roller.

Even though the four alternating magnetic poles were known to provide sufficient magnetism to pull enough developer material from the reservoir, by the present invention additional magnetic poles are supplied so that there is an odd number of alternating magnetic poles in the region of the transport roller adjacent to the reservoir. By so doing, it is assured that the magnetic poles on the ends of the assembly of poles are of the same polarity. This prevents the existence of a magnetic flux line extending around the transport roller across the region of the developer roller. When these flux lines are eliminated, the amount of developer material sticking to the transport roller and not being transferred to the development roller is greatly reduced, thereby increasing the efficiency of the development station.

Accordingly, it is a feature of the present invention to provide a development station for a reproduction apparatus that includes a housing forming a reservoir, a developer roller for delivering developer material to a development zone, and a transport roller for moving developer material from said reservoir to said developer roller. The transport roller includes a rotating shell and a stationary core having an odd number of alternating North and South magnetic poles, wherein the number of magnetic poles is at least five. In one preferred embodiment of the present invention, the transport roller consists of five alternating North and South magnetic poles.

### BRIEF DESCRIPTION OF THE DRAWINGS

FIG. 1 is an end view, partly in cross-section, of a reproduction apparatus magnetic brush development station;

FIG. 2 is an end cross-sectional view of a transport roller according to the prior art; and

FIG. 3 is an end cross-sectional view of a transport roller according to the present invention.

### DETAILED DESCRIPTION OF THE INVENTION

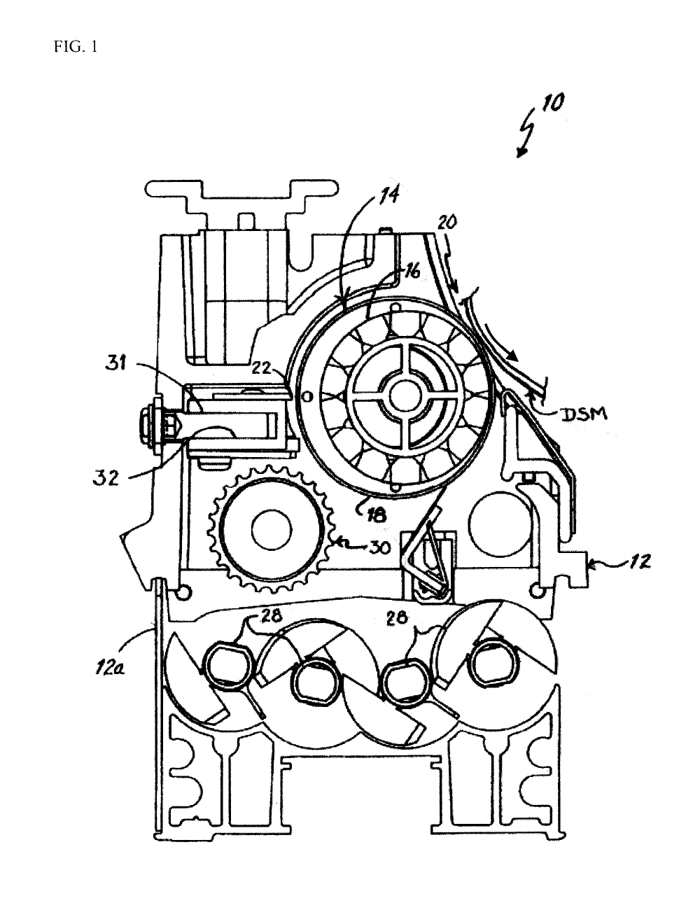

Referring now to the accompanying drawings, FIG. 1 shows a reproduction apparatus magnetic brush development station 10 that includes a housing 12 forming, in part, a reservoir for developer material. Development station housing 12 is locatable in a reproduction apparatus in operative association with a dielectric support member DSM adapted to carry latent image charge patterns, and have developer material images formed of such latent image charge patterns, which are thereafter transferred to receiver sheets to form desired reproductions. The housing forming, at least in part, a reservoir for developer material, a photoconductor, a magnetic brush contacting the photoconductor, where the magnetic brush includes a mixture of toner and magnetic carriers and has a magnetic core within a shell having a center of rotation, and said magnetic core is offset relative to said center of rotation toward said drum photoconductor. Since this arrangement is well known in the art, the overall reproduction apparatus is not shown in the accompanying drawings.

As described above, the developer material may be single-component or two-component, but in this illustrative embodiment, it is two-component. As such, a plurality of augers 28 are provided, and have suitable mixing paddles for stirring the developer material within a reservoir 12a of housing 12. A developer roller 14, mounted within development station housing 12, includes a rotating (counterclockwise in FIG. 1) fourteen-pole core magnet 16 inside a rotating (clockwise in FIG. 1) shell 18. Of course, core magnet 16 and shell 18 can have any other suitable relative rotation, which causes developer material to be transported to a development zone 20 into operative association with dielectric support member DSM to develop latent image charge patterns thereon.

A quantity of developer material is delivered by a transport roller 30 from the reservoir portion of housing 12 to developer roller 14. The amount of developer material delivered to development zone 20 is controlled by a metering skive 22 positioned parallel to the longitudinal axis of developer roller 14, at a location upstream in the direction of shell rotation prior to development zone 20. To provide for selective movement of the metering skive 22, as shown in FIG. 1, the metering skive 22 is supported on a member mounted for movement perpendicular to the longitudinal axis of developer roller 14. The support for metering skive 22 is provided by a plurality of guide pins 31 spaced along the length of the metering skive and are respectively received within a plurality of bores 32

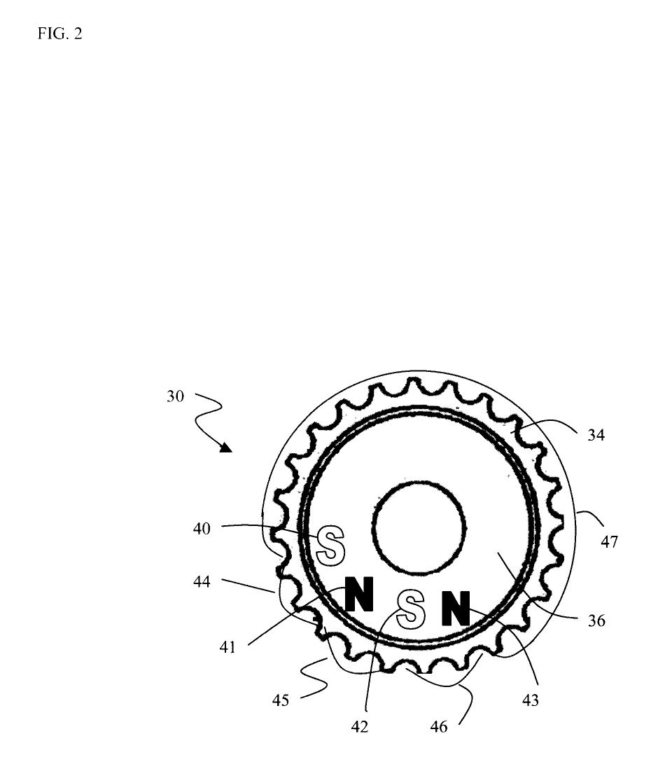

A conventional transport roller 30 is shown in FIG. 2 and includes a non-magnetic tubular member 34 having a roughened exterior circumferential surface. Tubular member 34 is mounted rotatably on suitable bearings. A motor (not shown) rotates tubular member 34. A magnet core 36 is disposed interiorly of tubular member 34. Magnet core 36 is mounted fixedly with a four alternating magnetic poles positioned in the region of the transport roller adjacent to the reservoir 12a. The magnetic flux fields associated with the four magnetic poles denoted by reference numerals 40, 41, 42 and 43 set up flux fields 44, 45, 46 and 47. The strong magnetic forces of flux fields 44, 45 and 46 beneficially attract the developer material from reservoir 12a onto the transport roller.

Although four alternating magnetic poles 40, 41, 42 and 43 cause sufficient developer material to adhere to the transport roller, the magnetic force from flux field 47 detrimentally tends to hold a portion of the developer material on the transport roller rather than allow it to be attracted onto development roller shell 18 by forces associated with the magnetic field of core magnet 16. That portion of the developer material is returned to the reservoir 12a as non-magnetic tubular member 34 continues to rotate.

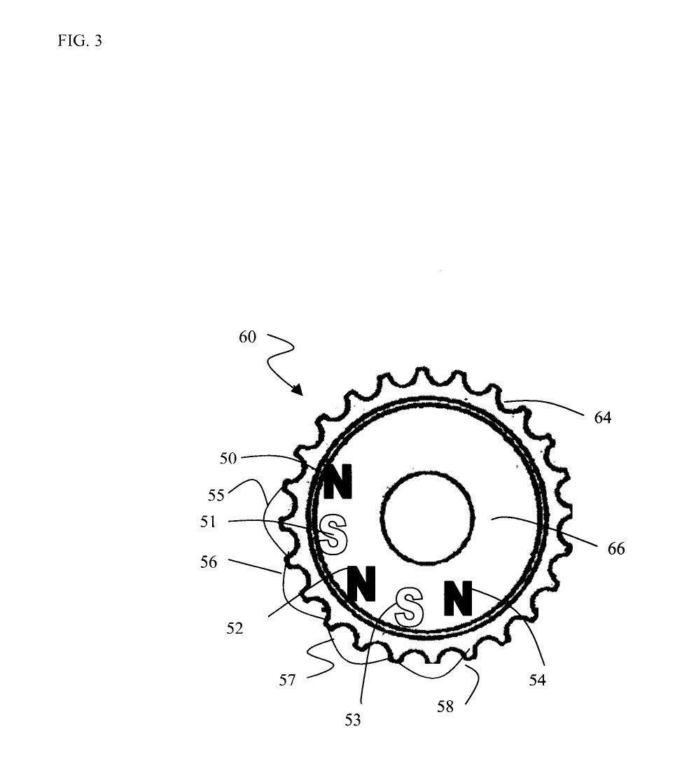

Referring to FIG. 3, transport roller 60 includes a non-magnetic tubular member 64 having a roughened exterior circumferential surface. Tubular member 64 is mounted rotatably on suitable bearings. A motor (not shown) rotates tubular member 64. A magnet core 66 is disposed interiorly of tubular member 64. Magnet core 66 is mounted fixedly with five alternating magnetic poles 50, 51, 52, 53 and 54 positioned in the region of the transport roller adjacent to reservoir 12a. The magnetic flux fields associated with the five magnetic poles are denoted by reference numerals, which set up four flux fields 55, 56, 57 and 58. The strong magnetic forces of flux fields 55, 56, 57 and 58 beneficially attract the developer material from reservoir 12a onto the transport roller. Note that because there are an odd number of alternating magnetic poles in the region of the transport roller adjacent to the reservoir, it is assured that the magnetic poles on the ends of the assembly of poles are of the same polarity. This prevents the existence of a magnetic flux line extending around the transport roller across the region of the developer roller. When these flux lines are eliminated, the amount of developer material sticking to the transport roller and not being transferred to the development roller is greatly reduced, thereby increasing the efficiency of the development station.

Several experiments were conducted comparing the efficiency of transfer rollers having five magnetic poles to conventional transfer rollers having four magnetic poles. Various parameters were varied during the experiments to ensure that the results were universal regardless of the set up of the test apparatus. Such parameters included mixer speed, transport roller speed, core speed of the developer roller, and spacing between the various elements. In every experiment run, the transfer roller having five magnetic poles transferred about 30% more developer mix to the developer roller than was transferred by the transfer roller having only four magnetic poles.

Even though the illustrative embodiment includes five alternating magnetic poles in the region of the transport roller adjacent to the reservoir, the benefits obtained by present invention are extendable to any odd number of magnetic poles greater than three. Three magnetic poles are not considered to be useful because three poles do not exhibit sufficient magnetism to pull enough developer material from reservoir 12a.

The invention has been described in detail with particular reference to certain preferred embodiments thereof, but it will be understood that variations and modifications can be effected within the spirit and scope of the invention.

### PARTS LIST

10 Magnetic brush development station
12 Housing
12a Reservoir
14 Developer roller
16 Core magnet
18 Shell
20 Development zone
22 Metering skive
28 Augers
30 Transport roller
31 Guide pins
32 Bores
34 Tubular member
36 Magnetic core
40 Magnetic pole
41 Magnetic pole
42 Magnetic pole
43 Magnetic pole
44 Flux field
45 Flux field
46 Flux field
47 Flux field
50 Magnetic pole
51 Magnetic pole
52 Magnetic pole
53 Magnetic pole
54 Magnetic pole
55 Flux field
56 Flux field
57 Flux field
58 Flux field
60 Transport roller
64 Tubular member
66 Magnetic core

1. A development station for a reproduction apparatus, said development station comprising:
a housing forming, at least in part, a reservoir for developer material;
a developer roller in the housing for delivering developer material to a development zone; and
a transport roller for moving developer material from said reservoir to said developer roller, said transport roller comprising a rotating shell and a stationary core having an odd number of alternating North and South magnetic poles, wherein the number of magnetic poles is at least five.

2. The apparatus of claim 1, wherein:
said transport roller rotating shell is a non-magnetic tubular member; and
said stationary core comprises an elongated magnet positioned interiorly of and spaced from said tubular member.

3. The development station as set forth in claim 1 wherein the transport roller consists of five alternating North and South magnetic poles.

4. The apparatus of claim 3, wherein:
said transport roller rotating shell is a non-magnetic tubular member; and
said stationary core comprises an elongated magnet positioned interiorly of and spaced from said tubular member.

5. The apparatus of claim 1, the developer roller further comprising a rotating magnetic core having an even number of alternating North and South poles, a transport roller with an odd number of alternating North and South magnetic poles, wherein the number of magnetic poles is at least five.

6. The apparatus of claim 5, the transport roller having no magnetic poles adjacent the developer roller.

7. The apparatus of claim 6, wherein at least one magnetic pole in the transport roller adjacent the developer reservoir and not adjacent the developer roller.

8. The apparatus of claim 5, further having a magnetic field of the developer roller greater in magnitude than a magnetic field of the transport roller where the transport roller is adjacent the developer roller.

9. The apparatus of claim 5, such that a force on the developer due to a magnetic field of the developer roller is greater in magnitude than a force on the developer due to a magnetic field of the transport roller where the transport roller is adjacent the developer roller.

10. The apparatus of claim 5, such that a force on the developer toward the developer roller due to a time varying magnetic field of the developer roller is instantaneously greater in magnitude than a force on the developer due to a magnetic field of the transport roller where the transport roller is adjacent the developer roller.

11. A development station for a reproduction apparatus, said development station comprising:
a housing forming, at least in part, a reservoir for developer material;
a developer roller in the housing for delivering developer material to a development zone, the developer roller containing a rotating magnetic core having an even number of alternating North and South poles; and
a transport roller for moving developer material from said reservoir to said developer roller, said transport roller comprising a rotating shell and a stationary core having an odd number of alternating North and South magnetic poles, wherein the number of magnetic poles is at least five such that there are no magnetic poles in the transport roller adjacent the developer roller magnetic poles and at least one magnetic pole in the transport roller is adjacent the developer reservoir and not adjacent the developer roller

12. The apparatus of claim 11, wherein:
said transport roller rotating shell is a non-magnetic tubular member; and
said stationary core comprises an elongated magnet positioned interiorly of and spaced from said tubular member.

13. The development station as set forth in claim 11 wherein the transport roller consists of five alternating North and South magnetic poles.

14. The apparatus of claim 13, wherein:
said transport roller rotating shell is a non-magnetic tubular member; and said stationary core comprises an elongated magnet positioned interiorly of and spaced from said tubular member.

15. The apparatus of claim 13, further having a magnetic field of the developer roller greater in magnitude than a magnetic field of the transport roller where the transport roller is adjacent the developer roller.

16. The apparatus of claim 13, such that a force on the developer due to a magnetic field of the developer roller is greater in magnitude than a force on the developer due to a magnetic field of the transport roller where the transport roller is adjacent the developer roller.

17. The apparatus of claim 13, such that a force on the developer toward the developer roller due to a time varying magnetic field of the developer roller is instantaneously greater in magnitude than a force on the developer due to a magnetic field of the transport roller where the transport roller is adjacent the developer roller.

18. An apparatus for developing an electrostatic image, comprising:
a housing forming, at least in part, a reservoir for developer material;
a photoconductor;
a magnetic brush contacting said photoconductor, said magnetic brush comprising a mixture of toner and magnetic carriers wherein said magnetic brush comprises a magnetic core within a shell having a center of rotation, and said magnetic core is offset relative to said center of rotation toward said drum photoconductor;
a developer roller in the housing for delivering developer material to a development zone; and
a transport roller for moving developer material from said reservoir to said developer roller, said transport roller comprising a rotating shell and a stationary core having an odd number of alternating North and South magnetic poles, wherein the number of magnetic poles is at least five.

19. The apparatus of claim 18, wherein the transport roller consists of five alternating North and South magnetic poles.

20. The apparatus of claim 19, wherein:
said transport roller rotating shell is a non-magnetic tubular member; and
said stationary core comprises an elongated magnet positioned interiorly of and spaced from said tubular member.
